(19) United States
(12) Patent Application Publication
(10) Pub. No.: US 2025/0104950 A1
(43) Pub. Date: Mar. 27, 2025

(54) Automatic Pre-Charge Device for High Power Electronic Circuit Contactor Control

(71) Applicant: John Strisower, Woodinville, WA (US)

(72) Inventor: John Strisower, Woodinville, WA (US)

(21) Appl. No.: 18/893,425

(22) Filed: Sep. 23, 2024

Related U.S. Application Data
(60) Provisional application No. 63/584,344, filed on Sep. 21, 2023.

(51) Int. Cl. H01H 50/58; H01H 50/14; H01H 50/54

(52) U.S. Cl. CPC H01H 50/58; H01H 50/14; H01H 50/543

(57) ABSTRACT

An automatic pre-charge device that eliminates the need for small contactors in high power contactor control circuits. To accomplish this, the device includes plurality of contactors, and an automated control board unit that has multiple interfaces for measuring and controlling the charging process. Further, the device reduces the number of additional wires and electrical connections, or reduces port count, thereby reducing the cost of the entire device. Furthermore, the device enables two methods of pre-charging that provide improved reliability and faster charging. Additionally, the device includes a programmable and automated digital control board that enables remote control as well as real time data acquisition information. Thus, the device is a smart and cost-effective addition to high power electronic circuits, for automatic pre-charge and surge protection.

The current application claims a priority to the U.S. provisional patent application Ser. No. 63/584,344 filed on Sep. 21, 2023. The current application is filed on Sep. 23, 2024, while Sep. 21, 2024 was on a weekend.

### FIELD OF THE INVENTION

The present invention relates generally to automatic pre-charge devices for high power contactors. More specifically, the present invention is an automatic pre-charge device that can prevent inrush current damage and extend the life of contactors with minimal additional circuit complexity and cost.

### BACKGROUND OF THE INVENTION

Connecting a high voltage electric motor to an expensive PLC (programmable logic controller) directly may damage the PLC cards if there are any electric surges on the motor's side. Pre-charging increases the lifespan of electric components and the reliability of the system as a whole. A pre-charge circuit allows the current to flow in a controlled manner until the voltage level rises to very near the source voltage before the main contactors are permitted to close. A typical arrangement of a contactor device includes two main contactors that are each pre charged with a resistor on a smaller contactor. When the small contactors are turned on, this allows current to slowly bring the voltage on the resistor side to the non-resistor side. The main contactor will be turned on when the voltage on both sides of the circuit is near zero. This arrangement increases the life of main contactors. However, the use of small pre-charge contactors does not give the user an idea of how much time will be required for the voltages to match or the difference in voltage to be near zero. Thus, a device that can eliminate the need of small contactors and additional circuitry but allows for pre-charging and increasing life span of main contactors and can further provide real time voltage data during the entire charging process is a rare find in the current market.

An objective of the present invention is to provide an automatic pre-charge device that eliminates the need for small contactors. Further, the present invention reduces the number of additional wires and electrical connections, or reduces port count, thereby reducing the cost of the entire device. Furthermore, the present invention enables two methods of pre-charging that provide improved reliability and faster charging. Additionally, the present invention comprises a programmable and automated digital control board that enables remote control as well as real time data acquisition information.

### SUMMARY OF INVENTION

The present invention is intended to provide users with an automatic pre-charge device that eliminates the need for small contactors in high power contactors. Further, the present invention reduces the number of additional wires and electrical connections, or reduces port count, thereby reducing the cost of the entire device. Furthermore, the present invention enables two methods of pre-charging that provide improved reliability and faster charging. Additionally, the present invention comprises a programmable and automated digital control board that enables remote control as well as real time data acquisition information. Thus, the present invention is a smart and cost-effective addition to high power electronic circuits, for automatic pre-charge and surge protection.

### BRIEF DESCRIPTION OF THE DRAWINGS

FIG. 1 is an overall schematic view of the present invention.

FIG. 2 is a top perspective view of the present invention.

FIG. 3 is a circuit diagram of the present invention.

### DETAILED DESCRIPTION OF THE INVENTION

All illustrations of the drawings are for the purpose of describing selected versions of the present invention and are not intended to limit the scope of the present invention.

The present invention is an automatic pre-charge device that can prevent inrush current damage and extend the life of contactors with minimal additional circuit complexity and cost.

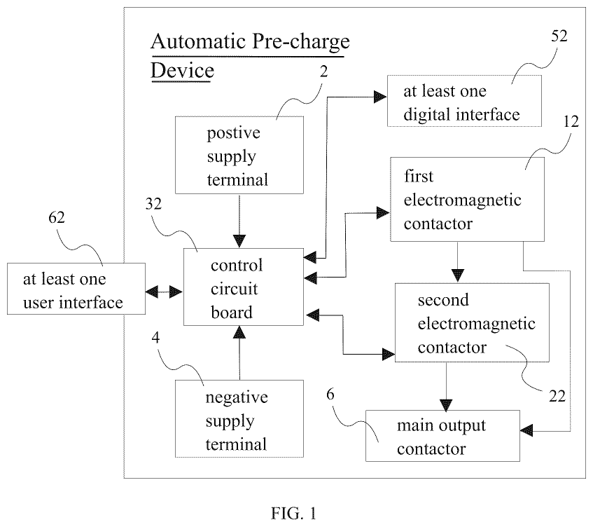

The following description is in reference to FIG. 1 through FIG. 3. According to a preferred embodiment, the present invention comprises a positive supply terminal 2, a negative supply terminal 4, a main output contactor 6, a first electromagnetic contactor 12, a second electromagnetic contactor 22, a control circuit board 32, and at least one digital interface 52. Usually, a contactor is used to connect the PLC (programmable logic controller) of a high-power electric motor indirectly and safely. To that end, all contactors have a low voltage coil. Users connect the PLC output to this coil and this coil usually works with a 24-volt DC (direct current) signal. Once the coil is energized, an electromagnetic field will be created. This electromagnetic field then causes the three contacts of a 3-phase power system to be closed and that's how 3-phase power will reach the motor and turns the motor on. Accordingly, the positive supply terminal 2 and the negative supply terminal 4 constitute the power source that is electrically connected to the pre-charge device. Preferably, the positive supply terminal 2 is a DC power supply of 12, 24, or 48 Volts. However, any other source of power that is known to one of ordinary skill in the art may be used to charge the pre-charge device, as long as the intents of the present invention are not altered.

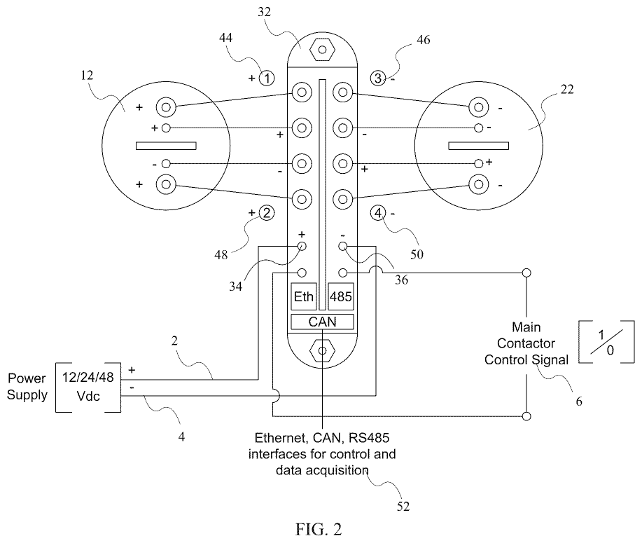

A contactor is an electrically controlled switching device, designed for repeatedly opening and closing a circuit. Contactors tend to be used for higher current-carrying applications than standard relays, which do a similar job with low current switching. Thus, the main contactor is an electrical device that is used for switching the high-power device on and off. To that end, the main output contactor 6 comprises a positive main input 8 and a negative main input 10. In reference to FIG. 2, the two big circles represent the first electromagnetic contactor 12 and the second electromagnetic contactor 22, and the two small circles within each big circle represent coils of the electromagnetic contactors.

An electric motor contactor is an electromagnetic switch used to control the flow of power to an electric motor. As a motor control accessory, it includes a coil, which is usually connected to a low-voltage control circuit, and a set of contacts, which regulate the high-voltage power circuit to the motor. When a voltage is applied to the coil, an electromagnetic field is created, which attracts a movable armature. This movement shuts the contacts, allowing current to flow from the power supply to start the motor. When the coil is de-energized, the contacts open, shutting down the motor. Thus, the first electromagnetic contactor 12, and the second electromagnetic contactor 22 play an important role in remote motor control and overload prevention.

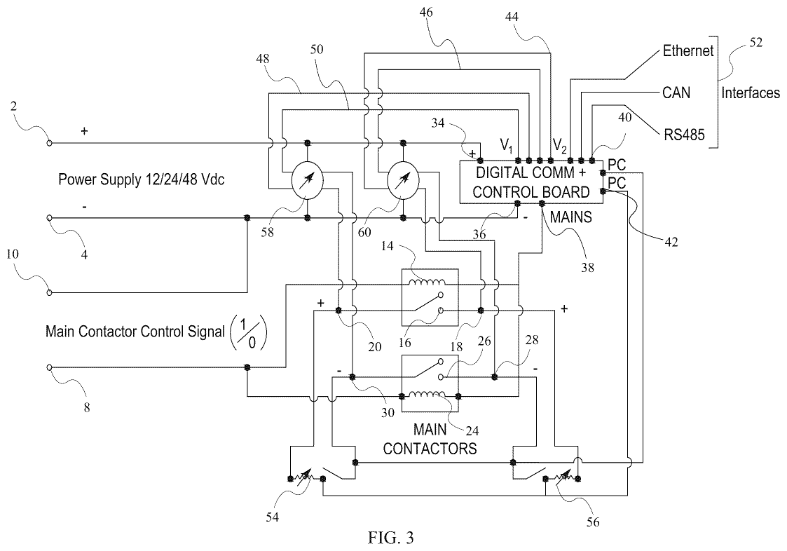

In the preferred, the control circuit board 32 is an electronic device that enables monitoring, performance evaluation, and overall controlling of the present invention. As seen in FIG. 2 and FIG. 3, the control circuit board 32 comprises a positive supply input 34, a negative supply input 36, a mains signal output 38, at least one interface input 40, and at least one control output 42. In other words, the control circuit board 32 has controls over various terminals of the present invention, and thus helps with the functioning of the present invention. Preferably, the positive supply terminal 2 is electrically connected to the positive supply input 34, and the negative supply terminal 4 is electrically connected to the negative supply input 36 and to the negative main input 10. In the preferred embodiment, the low power contactors control the pre-charging process or establish power connection between the mains power signal and the high-power electrical device connected to the end of the main contactor. In other words, the mains signal output 38 is electronically connected to the positive main input 8 through the first electromagnetic contactor 12 and the second electromagnetic contactor 22. Further, the at least one control output 42 is electronically connected to the first electromagnetic contractor and the second electromagnetic contactor 22.

According to the preferred embodiment, a plurality of interfaces or at least one digital interface 52 that enable data acquisition is integrated onto the digital communication control board. Examples of such interfaces include, but are not limited to Ethernet, CAN, RS485, etc. However, the digital communication control board may include any other ports, connections, technologies, etc. that are known to one of ordinary skill in the art, as long as the intents of the present invention are not altered. To enable data transfer, the at least one digital interface 52 is electronically connected to the at least one interface input 40.

A more detailed description of the present invention follows.

According to the preferred embodiment, and as seen in FIG. 2 and FIG. 3, the first electromagnetic contactor 12 comprises a first induction coil 14, and the second electromagnetic contactor 22 comprises a second induction coil 24. Preferably, the first induction coil 14 and the second induction coil 24 are electrically connected in parallel to each other. Further, the mains signal output 38 is electrically connected to the positive main input 8 through the first induction coil 14 and the second induction coil 24. This is so that, the electromagnetic field created by the first induction coil 14 and the second induction coil 24 causes the three contacts of a 3-phase power system to be closed and the 3-phase power or positive main input 8 will reach the motor and turns the motor on.

Continuing with the preferred embodiment, the first electromagnetic contactor 12 comprises a first contact switch 16, a first positive switch terminal 18, and a second positive switch terminal 20. Also for the preferred embodiment, the second electromagnetic contactor 22 comprises a second contact switch 26, a first negative switch terminal 28, and a second negative switch terminal 30. Preferably, the first positive switch terminal 18 is electrically connected to the second positive switch terminal 20 through the first contact switch 16, and the first negative switch terminal 28 is electrically connected to the second negative switch terminal 30 through the second contact switch 26. Furthermore, the at least one control output 42 is electronically connected to the first positive switch terminal 18, the second positive switch terminal 20, the first negative switch terminal 28, and the second negative switch terminal 30. All these connections enable pre-charging and controlling of the high-power electric device through the automated pre-charge device.

According to the present invention, pre-charging can happen in two different ways. One method is called variable resistor method wherein multiple resistors are connected in parallel as seen in FIG. 3, and charging happens through the resistors based on the requirement of the contactors and the high-power electronic circuit. Accordingly, the present invention may further comprise a first switchable variable resistor 54 and a second switchable variable resistor 56. Preferably, the first positive switch terminal 18 is electrically connected to the first negative switch terminal 28 through the first switchable variable resistor 54, and the second positive switch terminal 20 is electrically connected to the second negative switch terminal 30 through the second switchable variable resistor 56. Further, the first switchable variable resistor 54 and the second switchable variable resistor 56 are electronically connected to each other, the at least one control output 42 is electronically connected to the first switchable variable resistor 54 and the second switchable variable resistor 56. These connections and the pre-charging through the variable resistors enable users to fix a predefined time and/or resistance for pre-charging, thereby providing a more controlled and power saving method of charging.

In order to accomplish smooth functioning, the present invention may further comprise the following terminals on the control circuit board 32. More specifically, the control circuit board 32 may further comprise a first voltage positive output 44, a first voltage negative output 46, a second voltage positive output, and a second voltage negative output 50. As seen in FIG. 3, the first voltage positive output 44 (V2 in FIG. 3) is electrically connected to the first positive switch terminal 18, and the first voltage negative output 46 is electrically connected to the first negative switch terminal 28. Further, the second voltage positive output 48 (V1 in FIG. 3) is electrically connected to the second positive switch terminal 20, the second voltage negative output 50 is electrically connected to the second negative switch terminal 30. These connections enable the various components of the present invention to establish electrical and electronic connections directly and through the control circuit board 32 for the smooth operation of the present invention.

In reference to FIG. 2, the control circuit board 32 is represented by the elongated elliptical structure between the two big contactors, and the low power big contactors are connected to the automated pre-charge device through the input section of the control circuit board 32. As seen in FIG. 2, points 1 and 2 constitute the first voltage positive output 44 and the second voltage positive output 48 respectively, and points 3 and 4 constitute the first voltage negative output 46 and the second voltage negative output 50 respectively. Accordingly, points 1 and 2 are connected to the first electromagnetic contactor 12, and points 3 and 4 are connected to the second electromagnetic contactor 22.

According to the preferred embodiment, the pre-charge device measures the V_{DC}/V_{AC} (alternate current) across the first electromagnetic contactor 12 and the second electromagnetic contactor 22. In other words, real time voltage (or current if needed) across the above-mentioned points is measured before initiating pre-charging. To actuate pre-charging, a ΔV or target voltage difference, is automatically set on the pre-charge device through the digital communicated control board or the ΔV is programmed. More specifically, automatic pre-charge happens until the difference between the two main contactors is less than the prefixed ΔV. Once pre-charging is complete, the main contactor connection closes and power will be transferred to the PC mains (program controller mains) of the high-power electronic circuit.

Continuing with the preferred embodiment, another method of pre-charging includes equalizing the voltage on both sides by matching the voltage on either side or reaching the target ΔV. For example, if the voltage between node 1 and node 3 is 1000V (volts) and that between node 2 and node 4 is 200 V, the section between nodes 2 and 4 will be charged close to 1000V such that the difference between the two sections or ΔV is close to zero or equal to the set target value. Once the target voltage is achieved as monitored by the digital control board, the main contactor or main output contactor 6 is closed automatically. This method of charging is called the DC-DC method, and it is an isolated and more reliable method of pre-charging that provides more control.

To accomplish the above method of pre-charging, the present invention may further comprise a first multimeter 58 and a second multimeter 60. As seen in FIG. 3, the first multimeter 58 is electrically connected across the electrical connection between the first voltage positive output 44 and the first positive switch terminal 18 and the electrical connection between the first voltage negative output 46 and the first negative switch terminal 28. Similarly, the second multimeter 60 is electrically connected across the electrical connection between the second voltage positive output 48 and the second positive switch terminal 20 and the electrical connection between the second voltage negative output 50 and the second negative switch terminal 30. Thus, the present invention is an intelligent design that protects the high-power electrical circuit, increases the life span of contactors, and saves overall powering time by reducing the pre-charging time with the help of two charging methods.

In order to read, control, and monitor the functions of the automatic pre-charging device, the present invention may further comprise at least one user interface 62, wherein the at least one user interface 62 is electronically connected to the control circuit board 32. It should be noted that, any other components, arrangement of components, additional circuitry, etc. that are known to one of ordinary skill in the art may be incorporated into the automatic pre-charging device falls under the scope of the invention, as long as the intents of the of the present invention are not altered.

Although the invention has been explained in relation to its preferred embodiment, it is to be understood that many other possible modifications and variations can be made without departing from the spirit and scope of the invention as hereinafter claimed.

What is claimed is:

1. An automatic pre-charge device for a high-power contactor comprising:
a positive supply terminal;
a negative supply terminal;
a main output contactor;
a first electromagnetic contactor;
a second electromagnetic contactor;
a control circuit board;
at least one digital interface;
the main output contactor comprising a positive main input and a negative main input;
the control circuit board comprising a positive supply input, a negative supply input, a mains signal output, at least one interface input, and at least one control output;
the positive supply terminal being electrically connected to the positive supply input;
the mains signal output being electronically connected to the positive main input through the first electromagnetic contactor and the second electromagnetic contactor;
the negative supply terminal being electrically connected to the negative supply input and to the negative main input;
the at least one digital interface being electronically connected to the at least one interface input; and
the at least one control output being electronically connected to the first electromagnetic contractor and the second electromagnetic contactor.

2. The automatic pre-charge device for a high-power contactor as claimed in claim 1 comprising:
the first electromagnetic contactor comprising a first induction coil;
the second electromagnetic contactor comprising a second induction coil;
the first induction coil and the second induction coil being electrically connected in parallel to each other; and
the mains signal output being electrically connected to the positive main input through the first induction coil and the second induction coil.

3. The automatic pre-charge device for a high-power contactor as claimed in claim 1 comprising:
the first electromagnetic contactor comprising a first contact switch, a first positive switch terminal, and a second positive switch terminal;
the second electromagnetic contactor comprising a second contact switch, a first negative switch terminal, and a second negative switch terminal;
the first positive switch terminal being electrically connected to the second positive switch terminal through the first contact switch;
the first negative switch terminal being electrically connected to the second negative switch terminal through the second contact switch; and
the at least one control output being electronically connected to the first positive switch terminal, the second positive switch terminal, the first negative switch terminal, and the second negative switch terminal.

4. The automatic pre-charge device for a high-power contactor as claimed in claim 3 comprising:
a first switchable variable resistor;
a second switchable variable resistor;
the first positive switch terminal being electrically connected to the first negative switch terminal through the first switchable variable resistor;
the second positive switch terminal being electrically connected to the second negative switch terminal through the second switchable variable resistor;
the first switchable variable resistor and the second switchable variable resistor being electronically connected to each other; and
the at least one control output being electronically connected to the first switchable variable resistor and the second switchable variable resistor.

5. The automatic pre-charge device for a high-power contactor as claimed in claim 3 comprising:
the control circuit board further comprising a first voltage positive output, a first voltage negative output, a second voltage positive output, a second voltage negative output;
the first voltage positive output being electrically connected to the first positive switch terminal;
the first voltage negative output being electrically connected to the first negative switch terminal;
the second voltage positive output being electrically connected to the second positive switch terminal; and
the second voltage negative output being electrically connected to the second negative switch terminal.

6. The automatic pre-charge device for a high-power contactor as claimed in claim 5 comprising:
a first multimeter;
a second multimeter;
the first multimeter being electrically connected across the electrical connection between the first voltage positive output and the first positive switch terminal and the electrical connection between the first voltage negative output and the first negative switch terminal; and
the second multimeter being electrically connected across the electrical connection between the second voltage positive output and the second positive switch terminal and the electrical connection between the second voltage negative output and the second negative switch terminal.

7. The automatic pre-charge device for a high-power contactor as claimed in claim 5 comprising:
at least one user interface; and
the at least one user interface being electronically connected to the control circuit board.

8. An automatic pre-charge device for a high-power contactor comprising:
a positive supply terminal;
a negative supply terminal;
a main output contactor;
a first electromagnetic contactor;
a second electromagnetic contactor;
a control circuit board;
at least one digital interface;
the main output contactor comprising a positive main input and a negative main input;
the control circuit board comprising a positive supply input, a negative supply input, a mains signal output, at least one interface input, and at least one control output;
the first electromagnetic contactor comprising a first induction coil;
the second electromagnetic contactor comprising a second induction coil;
the positive supply terminal being electrically connected to the positive supply input;
the mains signal output being electronically connected to the positive main input through the first electromagnetic contactor and the second electromagnetic contactor;
the negative supply terminal being electrically connected to the negative supply input and to the negative main input;
the at least one digital interface being electronically connected to the at least one interface input;
the at least one control output being electronically connected to the first electromagnetic contractor and the second electromagnetic contactor;
the first induction coil and the second induction coil being electrically connected in parallel to each other; and
the mains signal output being electrically connected to the positive main input through the first induction coil and the second induction coil.

9. The automatic pre-charge device for a high-power contactor as claimed in claim 8 comprising:
the first electromagnetic contactor comprising a first contact switch, a first positive switch terminal, and a second positive switch terminal;
the second electromagnetic contactor comprising a second contact switch, a first negative switch terminal, and a second negative switch terminal;
the first positive switch terminal being electrically connected to the second positive switch terminal through the first contact switch;
the first negative switch terminal being electrically connected to the second negative switch terminal through the second contact switch; and
the at least one control output being electronically connected to the first positive switch terminal, the second positive switch terminal, the first negative switch terminal, and the second negative switch terminal.

10. The automatic pre-charge device for a high-power contactor as claimed in claim 9 comprising:
a first switchable variable resistor;
a second switchable variable resistor;
the first positive switch terminal being electrically connected to the first negative switch terminal through the first switchable variable resistor;
the second positive switch terminal being electrically connected to the second negative switch terminal through the second switchable variable resistor;
the first switchable variable resistor and the second switchable variable resistor being electronically connected to each other; and
the at least one control output being electronically connected to the first switchable variable resistor and the second switchable variable resistor.

11. The automatic pre-charge device for a high-power contactor as claimed in claim 9 comprising:
the control circuit board further comprising a first voltage positive output, a first voltage negative output, a second voltage positive output, a second voltage negative output;
the first voltage positive output being electrically connected to the first positive switch terminal;
the first voltage negative output being electrically connected to the first negative switch terminal;
the second voltage positive output being electrically connected to the second positive switch terminal; and
the second voltage negative output being electrically connected to the second negative switch terminal.

12. The automatic pre-charge device for a high-power contactor as claimed in claim 11 comprising:
a first multimeter;
a second multimeter;
the first multimeter being electrically connected across the electrical connection between the first voltage positive output and the first positive switch terminal and the electrical connection between the first voltage negative output and the first negative switch terminal; and
the second multimeter being electrically connected across the electrical connection between the second voltage positive output and the second positive switch terminal and the electrical connection between the second voltage negative output and the second negative switch terminal.

13. The automatic pre-charge device for a high-power contactor as claimed in claim 11 comprising:
at least one user interface; and
the at least one user interface being electronically connected to the control circuit board.
